(19) United States
(12) Patent Application Publication
(10) Pub. No.: US 2008/0229651 A1
(43) Pub. Date: Sep. 25, 2008

(54) FISHHOOK REMOVING TOOL AND METHOD OF USE THEREOF

(76) Inventor: Norman L. Broadnax, Marietta, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/132,715

(22) Filed: Jun. 4, 2008

Related U.S. Application Data
(63) Continuation-in-part of application No. 11/605,994, filed on Nov. 29, 2006.

(51) Int. Cl. A01K 97/18; B25B 7/02

(52) U.S. Cl. 43/53.5; 81/426.5

(57) ABSTRACT

A pliers-type tool having gripping channels and a longitudinal axis, further comprises gripping ridges disposed at selected angles from the longitudinal axis to facilitate gripping a fishhook in different dispositions for extraction of the fishhook from a fish. An alternate embodiment comprises top and bottom end portions and a middle portion intermediate the top and bottom end portions. A shoulder connected to the top end portion has first and second portions offset from the longitudinal axis. A first hook engaging member joined to the first portion of the shoulder angularly extends toward the longitudinal axis. The first hook engaging member has an inner surface defining a plurality of grooves therein adapted to engage the fish hook to facilitate removal thereof from the fish's mouth.

### CROSS-REFERENCE TO RELATED APPLICATIONS

The present application is a continuation-in-part application to non-provisional patent application Ser. No. 11/605,994, entitled “FISH HOOK REMOVER”, filed on Nov. 29, 2006, and claims priority thereto and the full benefit thereof.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to tools for removing fishhooks from fish, and more specifically to a pliers device for securing a fishhook in the jaws thereof to facilitate extraction of the fishhook.

2. Description of Related Art

Fishing is an activity that can be enjoyed by persons of all ages; however, it is often necessary to be able to rapidly extract a fishhook from a captured fish in order to continue to fish in an area where fish are active without losing the school. Further, an aged person or a person with arthritis or with other diseases may have difficulty removing a fish hook unassisted because of a loss of dexterity or strength. Accordingly, it is highly desirable to have a simple tool for removing the hook that does not require a great deal of digital dexterity to manipulate, and which can rapidly remove a hook from a fish.

Moreover, there are various types of hooks that may be utilized at one time or another. Standard hooks with a shank and curved portion leading to a barbed tip are the most common. However, other styles of hooks exist, such as, for exemplary purposes only, a triple hook. Accordingly, it is desirable to have a fish hook removing tool that can accommodate and be utilized to remove a variety of different styles and/or types of hooks.

When fishing using a hook and line, one of the chores for the fisherman is removing the fishing hook from the mouth of the fish. This seemingly simple task is complicated by the size and shape of the hook, the size and shape of the fish, and the condition of the fisherman's hands. The hook normally includes a barb that prevents the hook from being easily pulled from the mouth of the fish. When the fish is to be released, as sometimes required or desired, the embedded barb must be dislodged from the soft tissue of the fish without causing irreparable harm. This is especially difficult in situations where the fish has deeply swallowed the hook. Even if the fish will not be released, the hook must still be removed so that the fisherman can continue fishing.

Because the slippery surface of the fish does not allow one to leverage the hook from the mouth by using one's fingers alone, a fisherman often resorts to using regular common pliers and/or needle nose pliers to remove the hook. The use of common pliers is not only cumbersome and ill-suited to the hook removal process, but can also damage the hook. Further, the hook can twist or slip within the pliers because only the shank is secured or because the shank and hook that is retained slides within the jaws of the pliers. This can be extremely frustrating to the fisherman when time is of the essence, and can be expensive for some types of hooks. It is therefore desirable to have a tool that effectively removes a hook with minimal damage to the hook and fish.

Another problem encountered in removing the hook is that the fishing line often gets in the way as the hook remover is maneuvered into position. The fishing line may also become damaged by the stretching and twisting of the hook remover, especially if the line is rubbed across the very fine, sharp teeth of some fish. Accordingly, it is highly desirable to have a tool for removing the hook that engages the line to keep it out of harms way.

Therefore, it is readily apparent that there is a need for a fishhook removal tool and method of use thereof, wherein the tool accommodates a variety of sizes and styles of hooks, and wherein the tool securely grasps the hook to facilitate removal of same from a fish.

### BRIEF SUMMARY OF THE INVENTION

Briefly described, in a preferred embodiment, the present invention overcomes the above-mentioned disadvantages and meets the recognized need for such a device by providing a fishhook removing tool and method of use thereof, wherein the fishhook removing tool comprises gripping channels and a longitudinal axis, wherein the gripping channels are disposed parallel to the longitudinal axis. The fishhook removing tool further comprises opposing plier-type head portions at one end of arm portions and handles at the other end of the arm portions, wherein the handles traverse around a pivot to become disposed on the opposite side of the apparatus from their respective arm portion. The head portions have gripping ridges/valleys thereon with several different orientations, including approximately parallel to the longitudinal axis, approximately perpendicular to the longitudinal axis and at approximately forty-five to sixty degrees from the longitudinal axis. Additionally, the arms have grooves for engaging and securing a fishing line to retain same out the way.

In an alternate embodiment, the fishhook removing tool comprises an elongated handle, top and bottom end portions and a middle portion intermediate the top and bottom end portions; a shoulder connected to the top end portion having first and second portions offset from the longitudinal axis; and a first hook engaging member joined to the first portion of the shoulder angularly extending toward the longitudinal axis. The first hook engaging member has a tip, an inner surface and an outer surface. The inner surface has a curved portion adapted to engage the fish hook to facilitate removal thereof from the fish's mouth. The inner surface and the outer surface define a furrow extending from the outer surface about the inner surface.

A second hook engaging member, with a tip, is joined to the second portion of the shoulder and angularly extends toward the longitudinal axis. The tips are spaced from one another and adapted to receive the shank of the hook therebetween. The inner surfaces of the hook engaging members each have a distal portion defining a tooth to aid in dislodging the hook. Similarly, the junctions of the shoulder and the hook engaging members define grooves to aid in dislodging the hook. The tool can be held in either hand and easily manipulated with one hand to dislodge the hook.

According to its major aspects and broadly stated, the present invention in its preferred form is a fishhook removing tool and method of use thereof, wherein the tool comprises a plier-like tool for removing a fish hook from a fish's mouth. The fishhook removing tool comprises gripping channels and a longitudinal axis, wherein the gripping channels are disposed parallel to the longitudinal axis each in a portion of at least one side of an operative head of the tool and is utilized for securing a shank portion of a fishhook. The operative head has an opening with tapers dimensioned to receive and retain a fishhook therewithin, and has two cooperating halves with sets of gripping ridges thereon. There is a tip set, a middle set, a lower set and an arm set. The tip set has its axis perpendicular to the longitudinal axis of the tool. The middle set has its axis approximately forty-five to sixty degrees from the longitudinal axis and the lower set has its principal axis parallel to the longitudinal axis. Finally, the arm set has its principal axis perpendicular to the longitudinal axis.

The head portion has a pair of mating dual-pronged jaw sections dimensioned to grasp a fishhook and the gripping ridges are disposed on the pair of mating dual-pronged jaw sections at different angles of approximately at least twenty degrees. On the arms of the fishhook removing tool there are grooves for receiving wrapped turns of a fishing line and a cutter for severing fishing line.

The fishhook removing tool is utilized by grasping a fishhook engaged with a fish and removing the fishhook from the fish, typically by twisting, rotating and/or pulling. Selectively, a shank portion of the fishhook is secured as needed in gripping channels that are disposed parallel to the longitudinal axis of the tool. Alternately, the shank portion shank portion of the fishhook is grasped with a set of gripping ridges, while other portions, such as, without limitation, the curved portion or the barbed tip portion of the fishhook are grasped by additional gripping ridges.

The tool in an alternate embodiment comprises first and second elongated members each having a longitudinal axis, a handle portion, a head portion and a pivot portion intermediate the handle and head portions with the elongated members being pivotally connected to one another at their pivot portions so that the head portions move between a closed position at which the head portions abut one another and an open position at which the head portions are spaced from one another; first and second shoulders each having first and second portions offset from a respective longitudinal axis and each being connected to a respective one of the head portions of each of the elongated members; first and second head members each respectively joined to the first and second portions of the first shoulder and angularly extending toward the longitudinal axis of the first elongated member with the first and second head members each defining an inner surface with a plurality of grooves therein adapted to engage the fish hook to facilitate removal thereof from the fish's mouth; and third and fourth head members each respectively joined to the first and second portions of the shoulder and angularly extending toward the longitudinal axis of the second elongated member with the third and fourth head members each defining an inner surface with a plurality of grooves therein adapted to engage the fish hook to facilitate removal thereof from the fish's mouth.

Each inner surface of each head member has a distal portion defining a tooth to aid in hook removal. A groove of each of the plurality of grooves of each the head members has a depth sufficient to receive the shank of the fish hook therein to grip the hook to aid in removal thereof. The plier-like tool can be held in either hand and easily manipulated with one hand to dislodge the hook.

More specifically, the present invention is a fishhook removing tool comprising a first head and second head, a first and second arm, a first and second handle, a pivot and a longitudinal axis. The first head is disposed at one end of the first arm and the first handle is disposed at the other end of the first arm. The second head is disposed at one end of the second arm and the second handle is disposed at the other end of the second arm. The first arm and the first handle are on opposite sides of the fishhook removing tool, traversing sides around the pivot and the second arm and the second handle are also on opposing sides of fishhook removing tool, traversing sides around the pivot. The operative connection of the first arm, the first handle, the second arm and the second handle are via pivot as such is known in the art for causing a scissors operation for pliers-type devices between the arms and handles thereof.

The first arm comprises a first groove array disposed on the outside thereof, and the second arm comprises a second groove array disposed on the outside thereof, wherein the first groove array and the second groove array are dimensioned to receive turns of fishing line therearound in order to secure same. Wrapping of fishing line permits engagement of the line to keep it out of harms' way while performing a hook extraction, as set forth more fully herein below.

The first arm and second arm each further comprise cutter halves, which when brought together, sever a fishing line therebetween.

The first arm and the second arm further comprise opposing gripping ridges disposed perpendicular to the longitudinal axis of the fishhook removing tool, thereby securing a shank portion of a fishhook when the shank is disposed perpendicular to the longitudinal axis which facilitates grasping of the barb tip with the middle grip ridges.

The first head and the second head cooperatively engage to secure therebetween a selected object, but more particularly to grip a fishhook within cooperative gripping channels disposed on the first and second heads. The gripping channels extend longitudinally through the first and second heads, parallel to the longitudinal axis of the fishhook removal tool, thereby securely retaining a fishhook by its shank, when the fishhook is placed between the first and second heads and same are closed together.

The first head further comprises first lower grip ridges and second head comprises second lower grip ridges, wherein the lower grip ridges oppose each other and engage any object placed therebetween, retaining the object securely upon pressing the handles together. The lower grip ridges are disposed parallel to the longitudinal axis, thereby facilitating grasping of the shank when same is secured in the gripping channels.

The first head further comprises first middle grip ridges and the second head comprises second middle grip ridges, wherein the middle grip ridges engage any object placed therebetween, retaining the object securely upon pressing the handles together. The middle grip ridges are disposed at an angle of approximately forty-five to sixty degrees from the longitudinal axis, thereby facilitating grasping of the shank when it is desired to secure the shank away from the arms to permit further grasping of the curved portion of the fishhook by the tip grip ridges.

The first head further comprises tip grip ridges and the second head comprises tip grip ridges, wherein the tip grip ridges of the first and second heads engage any object placed therebetween retaining the object securely upon pressing the handles together. The tip grip ridges are disposed perpendicular to the longitudinal axis, thereby facilitating grasping of the curved portion of the fishhook.

The combined first head and second head form a left tip, a right tip and an opening, wherein the opening has a left taper and a right taper, and wherein the left taper and the right taper are dimensioned to receive a portion of a fishhook, and, due to the tightened angular dimension and shape of the left taper and the right taper, the tapers secure the fishhook, thereby permitting retention of the fishhook during a quick twisting motion of the fishhook removing tool, wherein the fishhook is removed rapidly from a fish. Further, the fishing line secured to the fishhook can be securely retained in place while the fishhook is being extracted, or, alternately, the fishing line can be severed by force or cutting.

The left tip comprises a first left tip half and a second left tip half, and the right tip comprises a first right tip half and a second right tip half.

The first head is a mirror image of the second head, such that the first head forms a complementary mating surface with that of the second head for gripping objects between the first head and the second head, and, further the first and second heads for the channel when closed together.

To extract a fishhook from a fish, a selected portion of the fishhook is grasped between the first head and the second head. When it is desired to very securely retain a shank portion of the fishhook, the shank is disposed within the gripping channels. Closure of the heads envelops the shank, while the lower grip ridges engage the shank to secure same in place.

While the shank is retained in the channel, the fishhook can be disposed such that the shank and/or the curved portion are gripped by the middle grip ridges and/or the tip grip ridges to provide added security of the fishhook within the fishhook removing tool. The fishhook removing tool is subsequently twisted and/or turned to remove the fishhook from the fish.

When extracting a fishhook having a triple hook, the shank is grasped by the middle grip ridges, outboard of the arms with the curved portion of one of the individual hooks of the triple hook being retained by the tip grip ridges. Similarly, when it is desired to secure a single fishhook outboard of the arms, again the shank is secured by the middle grip ridges with the curved portion of the fishhook gripped by the tip grip ridges.

Additionally, the fishhook can be retained securely held by the fishhook removing tool by placing the shank perpendicular to the longitudinal axis, wherein the shank is gripped by the gripping ridges and the lower grip ridges. When so desired, the barb tip is selectively retained by the middle grip ridges.

Accordingly, a feature and advantage of the present invention is its ability to grip a fishhook securely to facilitate removal of same from a fish.

Another feature and advantage of the present invention is its ability to accommodate different sizes of hooks.

Still another feature and advantage of the present invention is its ability to accommodate different style or shapes of hooks.

Yet another feature and advantage of the present invention is its ability to grasp a fishhook by the shank portion only.

Yet still another feature and advantage of the present invention is its ability to retain the shank portion of a fishhook securely within a closed channel.

A further feature and advantage of the present invention is its ability to be utilized as a pair of pliers.

Yet still a further feature and advantage of the present invention is that it can be utilized to keep the fishing line securely out of the way when removing a fishhook.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a front view of a fishhook removing tool according to an alternate embodiment;

FIG. 2 is a side view of the tool of FIG. 1;

FIG. 3 is a diagram of an exemplary fish hook;

FIG. 4 is a top view of the tool of FIG. 1 with the jaws of the head closed;

FIG. 5 is a top view of the tool of FIG. 1 with the jaws of the head open;

FIG. 6 is a somewhat enlarged inside view of the right half of the head of the tool of FIG. 1 showing hook gripping grooves;

FIG. 7 is a somewhat enlarged inside view of the left half of the head of the tool of FIG. 1 showing hook gripping grooves;

FIG. 8 is an inside view of one half of the head of a fishing tool similar to FIGS. 6-7, but illustrating another alternate embodiment;

FIG. 9 is an inside view of one half of the head of a fishing tool similar to FIG. 8, but illustrating another alternate embodiment;

FIG. 10 is a tool for dislodging and removing a fish hook according to an alternate embodiment;

FIG. 11 is a head piece for a tool for dislodging and removing a fish hook according to an alternate embodiment;

FIG. 12 is a perspective view of a fishhook removing tool according to a preferred embodiment;

FIG. 13 is a surface view of a bottom jaw half of a fishhook removing tool according to a preferred embodiment, and is a mirror image of a top jaw half of a fishhook removing tool according to a preferred embodiment;

FIG. 14 is an end view of a tip portion of a fishhook removing tool according to a preferred embodiment;

FIG. 15A depicts a cross-sectional view of a head portion of a fishhook removing tool according to a preferred embodiment, shown grasping a triple hook;

FIG. 15B depicts a cross-sectional view of a head portion of a fishhook removing tool according to a preferred embodiment, shown grasping a single hook by shank and curve;

FIG. 15C depicts a cross-sectional view of a head portion of a fishhook removing tool according to a preferred embodiment, shown grasping a single hook by shank and tip;

FIG. 15D depicts a cross-sectional view of a head portion of a fishhook removing tool according to a preferred embodiment, shown grasping a single hook by its shank;

FIG. 16 depicts a perspective view of head and arm portions of a fishhook removing tool according to a preferred embodiment, shown grasping a single hook by its curved portion; and

FIG. 17 depicts a lower rear view of a fishhook removing tool according to a preferred embodiment.

### DETAILED DESCRIPTION OF THE PREFERRED AND SELECTED ALTERNATE EMBODIMENTS OF THE INVENTION

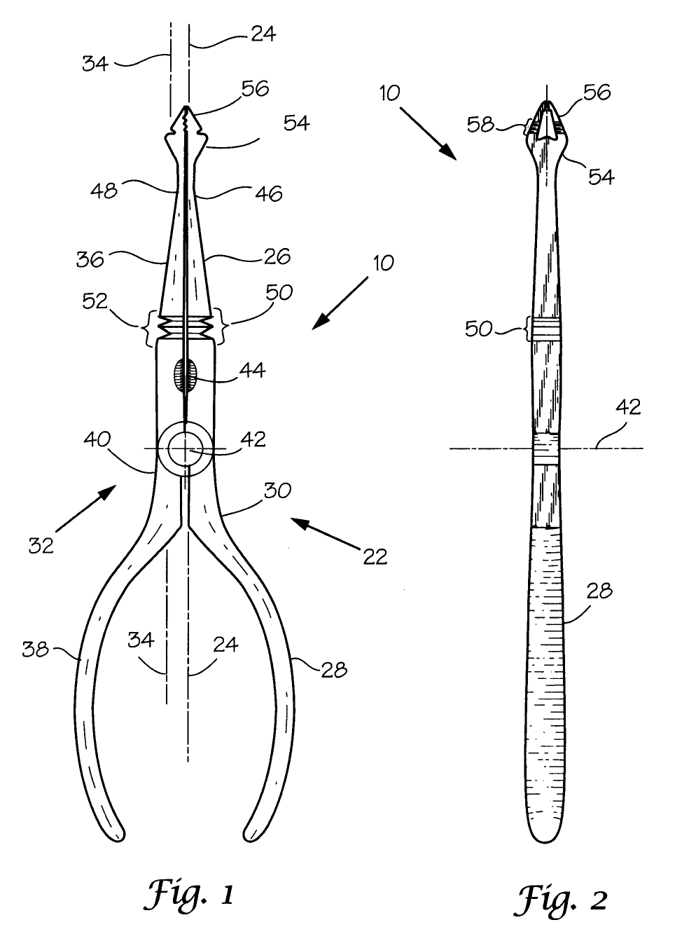

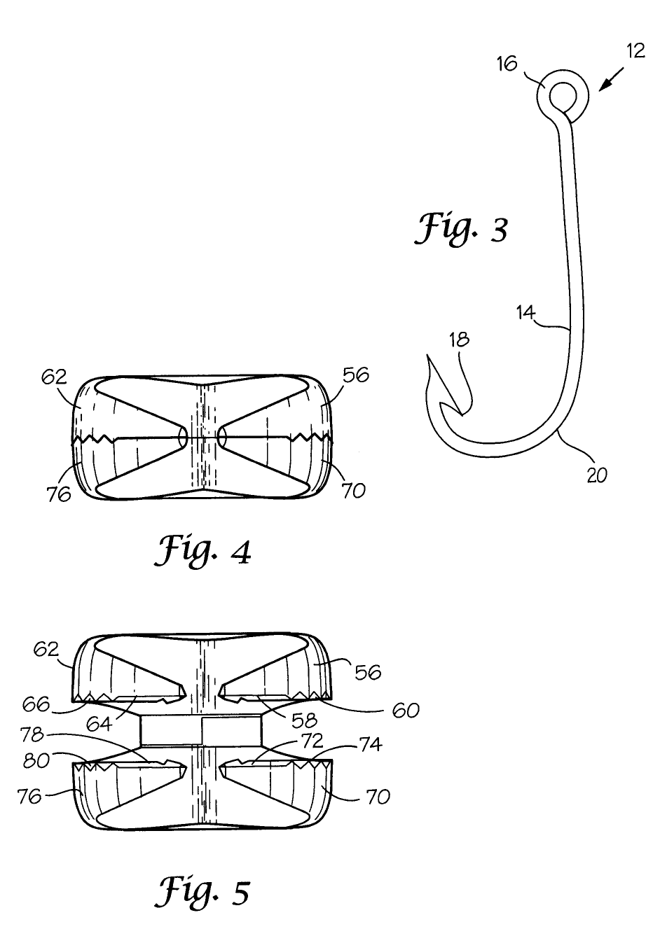

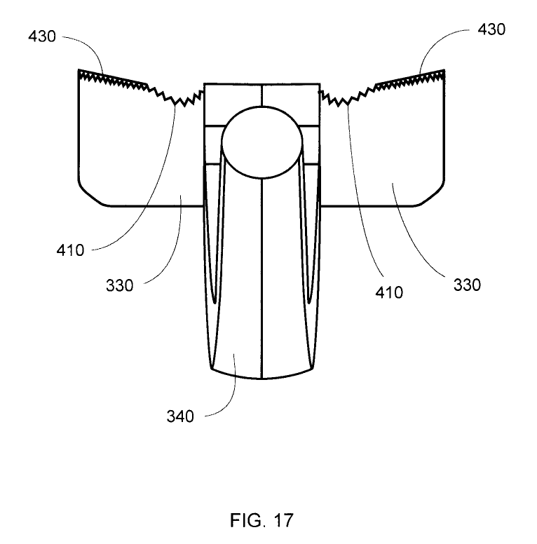

In describing the preferred and selected alternate embodiments of the present invention, as illustrated in FIGS. 1-17, specific terminology is employed for the sake of clarity. The invention, however, is not intended to be limited to the specific terminology so selected, and it is to be understood that each specific element includes all technical equivalents that operate in a similar manner to accomplish similar functions.

### Preferred Embodiment

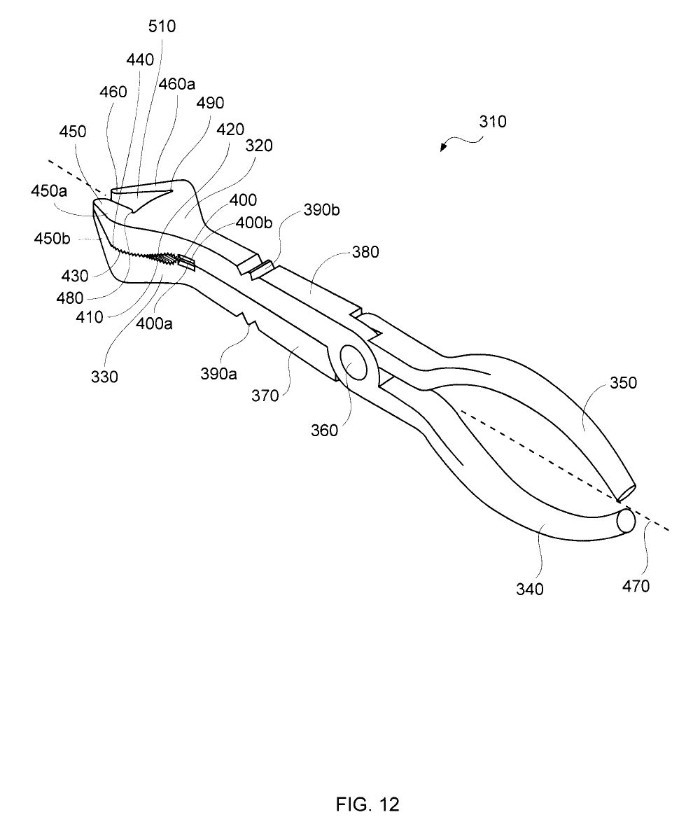

Referring now to FIGS. 12-17, depicted therein is a preferred embodiment of fishhook removing tool 310, wherein fishhook removing tool 310 comprises first head 320, first arm 380, second head 330, second arm 370, first handle 340, second handle 350, pivot 360 and longitudinal axis 470. First head 320 is disposed at one end of first arm 380 and first handle 340 is disposed at the other end of first arm 380. Second head 330 is disposed at one end of second arm 370 and second handle 350 is disposed at the other end of second arm 370. First arm 380 and first handle 340 are on opposite sides of fishhook removing tool 310, traversing sides around pivot 360 and second arm 370 and second handle 350 are also on opposing sides of fishhook removing tool 310, traversing sides around pivot 360. The operative connection of first arm 380, first handle 340, second arm 370 and second handle 350 via pivot 360 is such as is known in the art for causing a scissors operation for pliers-type devices between arms 370, 380 and handle 340, 350.

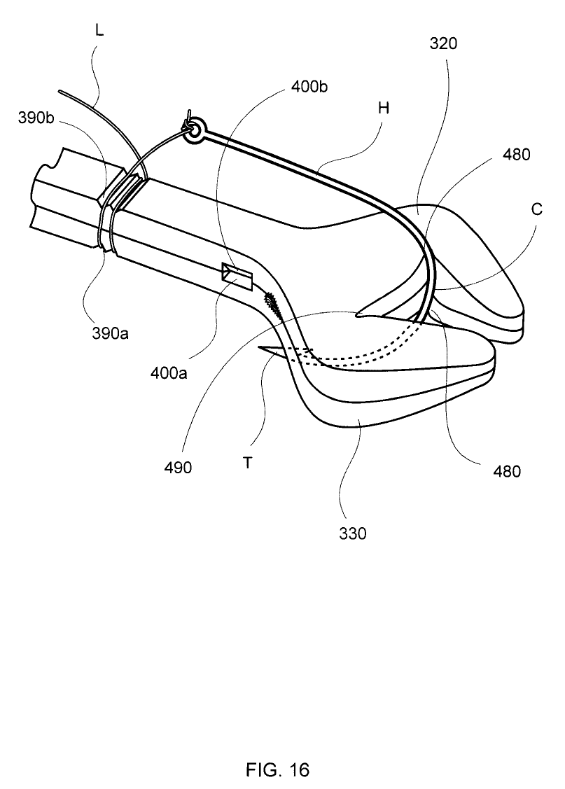

First arm 380 comprises first groove array 390b disposed on the outside thereof, and second arm 370 comprises second groove array 390a disposed on the outside thereof, wherein first groove array 390b and second groove array 390a are dimensioned to receive turns of fishing line L therearound in order to secure same (best shown in FIG. 16). Wrapping of fishing line permits engagement of the line to keep it out of harms' way while performing a hook extraction, as set forth more fully herein below.

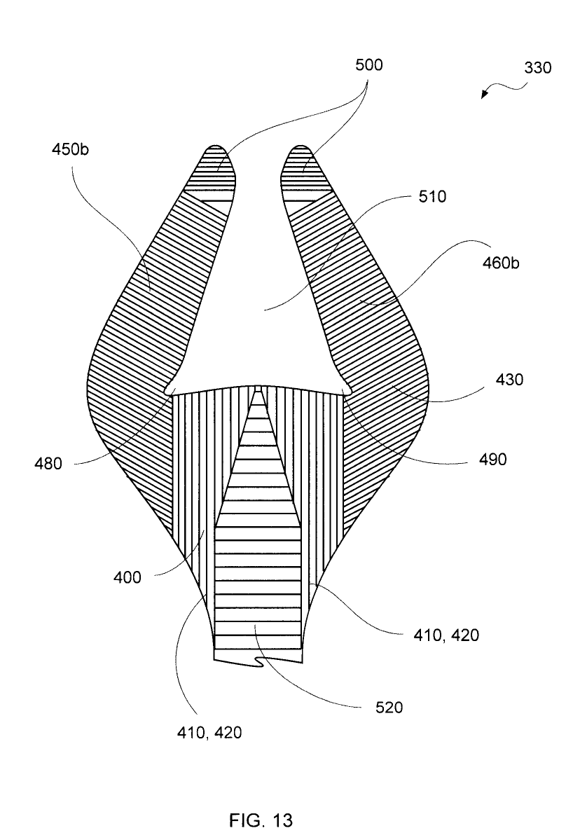

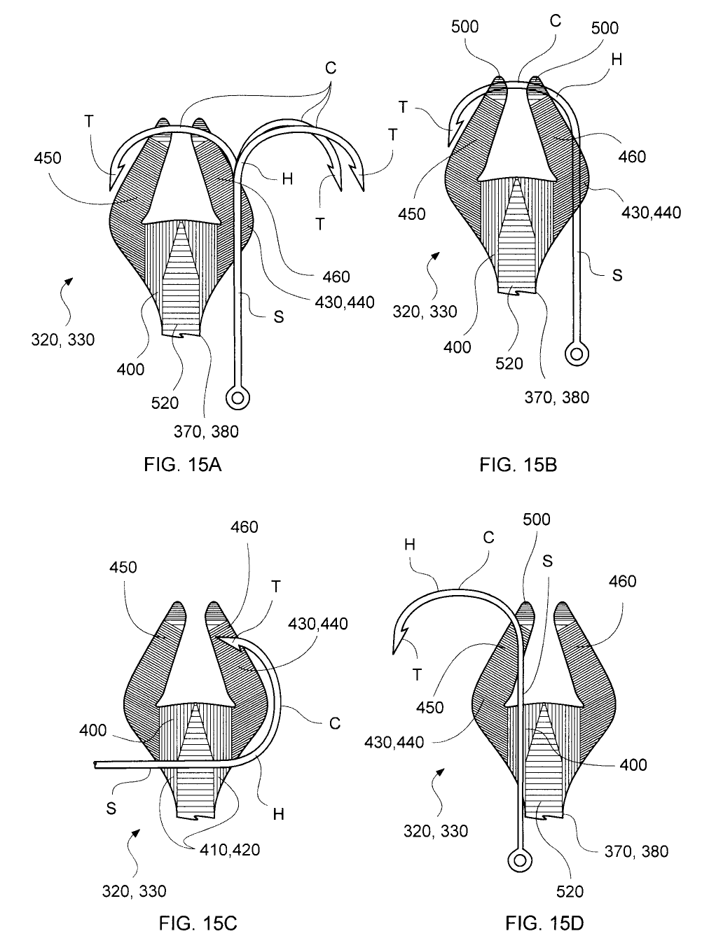

First arm 380 and second arm 370 further comprise opposing gripping ridges 520 (best shown in FIG. 13), wherein gripping ridges 520 are disposed perpendicular to longitudinal axis 470 of fishhook removing tool 310, thereby securing shank S (best shown in FIGS. 15A-D) when shank S is disposed perpendicular to longitudinal axis 470 to facilitate grasping of barb tip T with middle grip ridges 430, 440 (best shown in FIG. 15C).

First head 320 and second head 330 comprise the operative head of fishhook removing tool 310 and cooperatively engage to secure therebetween a selected object, but more particularly to grip fishhook H. First head 320 comprises second cutter half 400a and first cutter half 400b, wherein first and second cutter halves 400a, 440b cooperatively sever fishing line L disposed therebetween upon closure of fishhook removing tool 310.

First head 320 and second head 330 further comprise gripping channels 405, wherein gripping channels 405 extend longitudinally through first and second heads 320, 330 parallel to longitudinal axis 470 of fishhook removal tool 310, thereby securely retaining fishhook H by its shank S (best shown in FIG. 15D) when fishhook H is placed between heads 320, 330. Gripping channels 405 become wider and deeper as they progress inward from gripping ridges 430 toward longitudinal axis 470, thereby accommodating fishhooks L of larger and larger diameter.

First head 320 further comprises first lower grip ridges 420 and second head 330 comprises second lower grip ridges 410, wherein lower grip ridges 410, 420 oppose each other and engage any object placed therebetween, retaining the object securely upon pressing handles 340, 350 together. Lower grip ridges 410, 420 are disposed parallel to longitudinal axis 470, thereby facilitating grasping of shank S (best shown in FIG. 15D) when same is secured in gripping channels 405.

First head 320 further comprises first middle grip ridges 440 and second head 330 comprises second middle grip ridges 430, wherein middle grip ridges 430, 440 engage any object placed therebetween, retaining the object securely upon pressing handles 340, 350 together. Middle grip ridges 430, 440 are disposed at an angle of approximately forty-five to sixty degrees from longitudinal axis 470, thereby facilitating grasping of shank S when it is desired to secure shank S away from arms 370, 380 to permit further grasping of curved portion C of fishhook H by tip grip ridges 500 (best shown in FIGS. 15A and 15B).

First head 320 further comprises tip grip ridges 500 and second head 330 comprises tip grip ridges 500, wherein tip grip ridges 500 of first and second heads 320, 330 engage any object placed therebetween retaining the object securely upon pressing handles 340, 350 together. Tip grip ridges 500 are disposed perpendicular to longitudinal axis 470, thereby facilitating grasping of curved portion C of fishhook H (best shown in FIGS. 15A and 15B).

Combined first head 320 and second head 330 form left tip 450, right tip 460 and opening 510, wherein opening 510 comprises left taper 480 and right taper 490, and wherein left taper 480 and right taper 490 are dimensioned to receive curved portion of fishhook H, and wherein due to the tightened angular dimension and shape of left taper 480 and right taper 490, either left taper 480 and right taper 490 secure fishhook H, permitting rapid extraction of fishhook H by a quick twist of fishhook removing tool 310. Fishing line L is securely retained in place on groove arrays 390a, 390b by wrapping therearound, while fishhook H is being extracted, or, alternately, fishing line L can be severed by cutting force by closing cutting halves 400a and 400b through fishing line L.

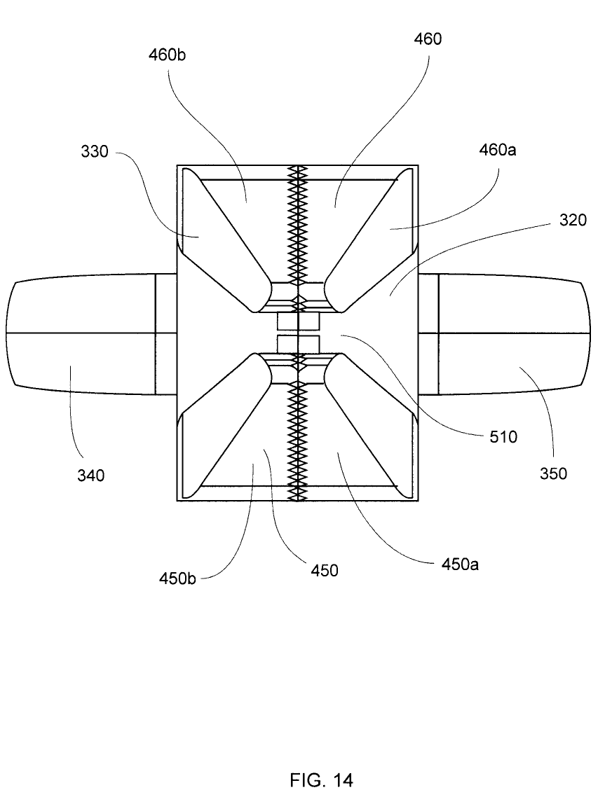

Left tip 450 comprises first left tip half 450a and second left tip half 450b, and right tip 460 comprises first right tip half 460a and second right tip half 460b (best shown in FIGS. 13 and 14).

Turning now more particularly to FIGS. 15A-15D, depicted therein is second head 330, wherein first head 320 is a mirror image of second head 330, such that first head 320 forms a complementary mating surface with that of second head 330 for gripping objects between first head 320 and second head 330. Accordingly, while second head 330 is shown, in operation with first head 320 and second head 330 closed together, the views of FIGS. 15A-15D comprise cross-sections of the disposed-together heads 320, 330.

In use, to extract fishhook H from a fish, a selected portion of fishhook H is grasped between first head 320 and second head 330. When it is desired to very securely retain shank S, shank S is disposed in gripping channels 405 (best shown in FIG. 15D). Closure of heads 320, 330 envelops shank S, while lower grip ridges 410, 420 engage shank S to secure same in place.

While shank S is retained in gripping channels 405, fishhook H can be disposed such that shank S and/or curved portion C are gripped by middle grip ridges 430, 440 and/or tip grip ridges 500 to provide added security of fishhook H within fishhook removing tool 310. Fishhook removing tool 310 is subsequently twisted and/or turned to remove fishhook H from a fish.

When extracting fishhook H comprising a triple hook (best shown in FIG. 15A), shank S is grasped by middle grip ridges 430, 440 outboard of arms 370, 380 with curved portion C of one of the individual hooks of the triple hook being retained by tip grip ridges 500. Similarly, when it is desired to secure single fishhook H outboard of arms 370, 380, again shank S is secured by middle grip ridges 430, 440 with curved portion C gripped by tip grip ridges 500.

Additionally, fishhook H can be retained securely held by fishhook removing tool 310 by placing shank S perpendicular to longitudinal axis 470, wherein shank S is gripped by gripping ridges 520 and lower grip ridges 410, 420. When so desired, barb tip T is selectively retained by middle grip ridges 430, 440.

Turning now more particularly to FIG. 16, in use, fishing line L is wrapped around grove arrays 390a and 390b, and fishhook H is grasped by inserting curved portion C in opening 510 such that curved portion C is disposed within either of left taper 480 or right taper 490 of fishhook removing tool 310. Tapering of left or right tapers 480, 490 engages and retains curved portion C therewithin, wherein subsequent twisting of fishhook removing tool 310 extracts fishhook H from a fish. Further, the remainder of fishhook H is retained outboard of the remainder of fishhook removing tool 310, secured only by the selected taper, thereby facilitating rapid use to remove fishhook H from a fish.

### Alternate Embodiments

Referring now more specifically to FIGS. 1-11, illustrated therein is an alternate embodiment of device 300. Specifically, in FIGS. 1-3, a plier-like tool 10 for dislodging and removing a fish hook 12 from a fish's mouth. Hook 12 typically has a shank 14 with an eyelet 16 on one end of shank 14 and a barb 18 on the other end, and has a curved portion 20 between shank 14 and barb 18. Barbless hooks can also used for fishing where the fish is to be released with minimal injury.

Tool 10 has a first elongated handle member 22 that has a first longitudinal axis 24, head or top end portion 26, and handle or bottom end portion 28 and a middle portion 30 intermediate the head and handle portions 26, 28. A second elongated handle member 32 has a second longitudinal axis 34, top or head portion 36, bottom end portion 38 and a middle portion 40 intermediate the head and handle portions 36, 38. First elongated handle 22 and second elongated handle 32 are connected in a scissors fashion about pivot point 42, wherein first head/top portion 26 is on the opposite side of tool 10 from first handle/bottom portion 28, and wherein second head/top portion 36 is on the opposite side of tool 10 from second handle/bottom portion 38, as such is known in the art for operation of a pliers-type device. The intermediate portions of the first and second elongated handle members 30, 40 are pivotally connected to one another at pivot point 42, wherein pivot point 42 is as such is known in the art for scissors-type operation of a pliers device.

Referring to FIGS. 4-5, the elongated handle members 22, 32 are pivotally connected to one another at pivot point 42 so that the head portions 26, 36 move between an open position and a closed position. At the open position, the head portions are spaced one from the other to allow entrance of hook 12 for contact with the interior surfaces of the head portions. At the closed position, head portions 26, 36 abut one another so that the shank 14 of hook 12 can be firmly grasped for removal. Referring to FIGS. 1-2, tool 10 preferably has a cutter 44 above pivot point 42, and plier blades 46, 48 above cutter 44. Plier blades 46, 48 are preferably elongated blades like the blades of needle nose pliers. An exterior surface of the top end portion 28 of the first elongated handle member 22 defines a groove 50 preferably above pivot point 42 in blade 46. Similarly, an exterior surface of the top end portion 38 of the first elongated handle member 32 defines a groove 52 preferably above pivot point 42 in blade 48. Grooves 50, 52 preferably extend along the curved surfaces of the sides or edges of blades 46, 48. Grooves 50, 52 are preferably aligned with one another to function as a single groove about the blades 46, 48 that aids with the line when removing a hook. Alternatively, the grooves can be vertically offset from one another and sized differently to accommodate various line diameters.

Referring now to FIGS. 1-7, a first shoulder member 54 is connected to the top end portion 26 of the first elongated handle member 22 and has first and second shoulder portions offset from the first longitudinal axis 24. A first head member or hook engaging member 56 is joined to the first shoulder portion and angularly extends toward first longitudinal axis 24. First hook engaging member 56 has an inner surface and an outer surface. The inner surface defines a plurality of upper grooves 58 and lower grooves 60 therein adapted to engage the fish hook to facilitate removal thereof from the fish's mouth. Upper grooves 58 are generally straight grooves adapted to engage the shank 14 of the hook 12 and are located near the upper end or tip of the tool 10. On the other hand, lower grooves 60 are generally curved to aid in grasping the curved portion 20 of hook 12. Lower grooves 60 are generally located away from upper end or tip of the tool 10 near the shoulder.

A second head member or hook engaging member 62 is joined to the second shoulder portion and angularly extends toward the first longitudinal axis 24. Second hook engaging member 62 has an inner surface and an outer surface. The inner surface defines a plurality of upper grooves 64 and lower grooves 66 therein adapted to engage the fish hook to facilitate removal thereof from the fish's mouth. Upper grooves 64 are generally straight grooves adapted to engage the shank 14 of the hook 12 and are located near the upper end or tip of the tool 10. On the other hand, lower grooves 66 are generally curved to aid in grasping the curved portion 20 of hook 12. Lower grooves 66 are generally located away from upper end or tip of the tool 10 near the shoulder.

A second shoulder member 68 is connected to the top end portion 36 of the second elongated handle member 32 and has third and fourth shoulder portions offset from the second longitudinal axis 34. A third head member or hook engaging member 70 is joined to the third shoulder portion and angularly extends toward second longitudinal axis 34. Third hook engaging member 70 has an inner surface and an outer surface. The inner surface defines a plurality of upper grooves 72 and lower grooves 74 therein adapted to engage the fish hook to facilitate removal thereof from the fish's mouth. Upper grooves 72 are generally straight grooves adapted to engage the shank 14 of the hook 12 and are located near the upper end or tip of the tool 10. On the other hand, lower grooves 74 are generally curved to aid in grasping the curved portion 20 of hook 12. Lower grooves 74 are generally located away from upper end or tip of the tool 10 near the shoulder.

A fourth head member or hook engaging member 76 is joined to the fourth shoulder portion and angularly extends toward second longitudinal axis 34. Fourth hook engaging member 76 has an inner surface and an outer surface. The inner surface defines a plurality of upper grooves 78 and lower grooves 80 therein adapted to engage the fish hook to facilitate removal thereof from the fish's mouth. Upper grooves 78 are generally straight grooves adapted to engage the shank 14 of the hook 12 and are located near the upper end or tip of the tool 10. On the other hand, lower grooves 80 are generally curved to aid in grasping the curved portion 20 of hook 12. Lower grooves 80 are generally located away from upper end or tip of the tool 10 near the shoulder.

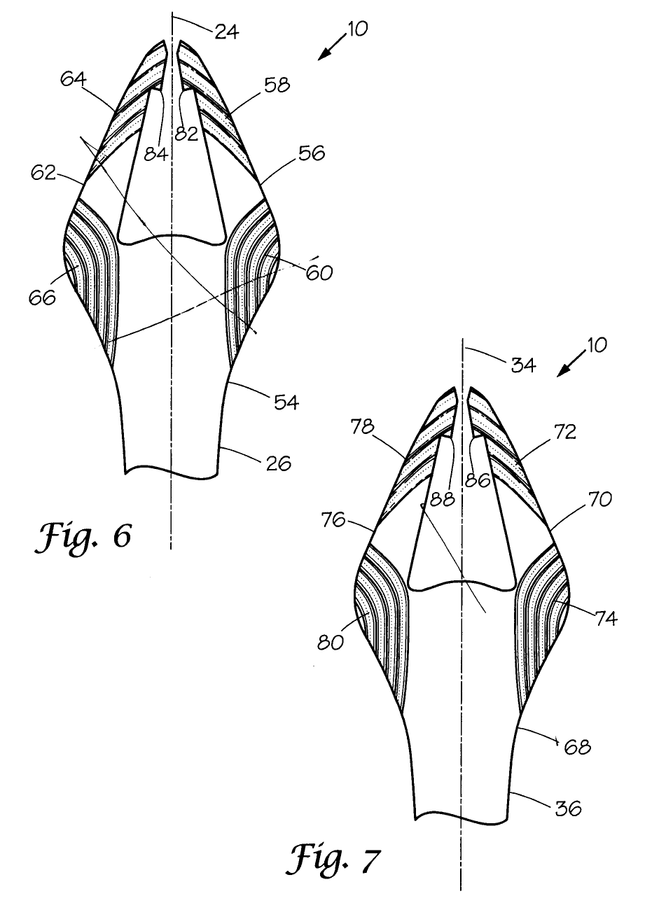

Referring to FIGS. 6-7, part of the difficulty of removing hooks is the inability to get a grip with bare fingers or leverage the hook with a tool. To engage the hook, each head member or hook engaging member has a downwardly projecting tooth that can contact the hook to provide a nudge to dislodge it. Thus, first head member or hook engaging member 56 has tooth 82 disposed on a distal end portion near the tip of the tool, and second head member or hook engaging member 62 has tooth 82 similarly disposed. Third head member or hook engaging member 70 has tooth 86 disposed on a distal end portion near the tip of the tool, and fourth head member or hook engaging member 76 has tooth 88 similarly disposed.

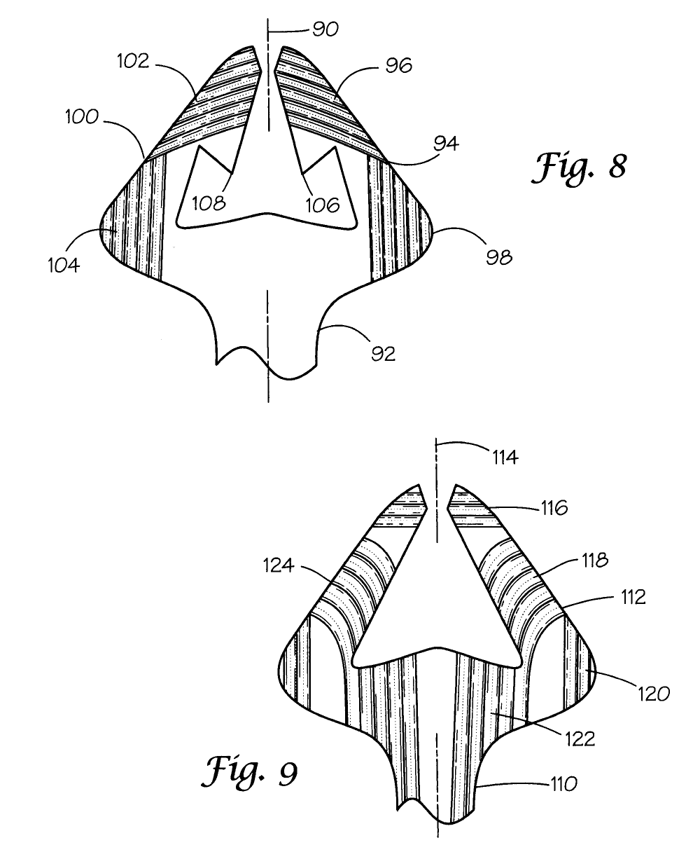

Referring to FIG. 8, another embodiment of the invention has a shoulder member 92 connected to the top end portion of an elongated handle member and has first and second shoulder portions offset from the first longitudinal axis. A first head member or hook engaging member 94 is joined to the first shoulder portion and angularly extends toward a longitudinal axis 90. First hook engaging member 94 has an inner surface and an outer surface. The inner surface defines a plurality of upper grooves 96 and lower grooves 98 therein adapted to engage the fish hook to facilitate removal thereof from the fish's mouth. Upper grooves 96 are generally straight grooves adapted to engage the shank of a hook and are located near the upper end or tip of the tool. Lower grooves 98 are generally straight grooves located away from upper end or tip of the tool near the shoulder. As illustrated, upper grooves 96 are disposed horizontally while lower grooves 98 are disposed vertically. By this construction, grooves are available to grasp the hook regardless of the orientation of the hook.

A second head member or hook engaging member 100 is joined to the second shoulder portion and angularly extends toward the longitudinal axis 90. Second hook engaging member 100 also has an inner surface and an outer surface. The inner surface defines a plurality of upper grooves 102 and lower grooves 104 therein adapted to engage the fish hook to facilitate removal thereof from the fish's mouth. Upper grooves 102 are generally straight grooves adapted to engage the shank of a hook and are located near the upper end or tip of the tool. Lower grooves 104 are generally straight grooves located away from upper end or tip of the tool near the shoulder. As illustrated, upper grooves 102 are disposed horizontally while lower grooves 104 are disposed vertically. By this construction, grooves are available to grasp the hook regardless of the orientation of the hook. The shoulder member 92 with attached head members 94, 100 cooperate with a facing shoulder member with attached head members on the plier like tool.

Again, some of the difficulty of removing hooks arises from the inability to get a grip with bare fingers or leverage the hook with a tool. To engage the hook, each head member or hook engaging member has a downwardly projecting tooth that can contact the hook to provide a nudge to dislodge it. Thus, first head member or hook engaging member 94 has tooth 106 disposed on a distal end portion near the tip of the tool, and second head member or hook engaging member 100 has tooth 108 similarly disposed.

Referring to FIG. 9, another embodiment of the invention has a shoulder member 110 connected to the top end portion of an elongated handle member and has first and second shoulder portions offset from the first longitudinal axis. A first head member or hook engaging member 112 is joined to the first shoulder portion and angularly extends toward a longitudinal axis 114. First hook engaging member 112 has an inner surface and an outer surface. The inner surface defines a plurality of upper grooves 116, intermediate or middle grooves 118, lower grooves 120 and shoulder grooves 122 therein adapted to engage the fish hook to facilitate removal thereof from the fish's mouth. As illustrated, upper grooves 116 are disposed horizontally while shoulder grooves 122 are disposed vertically. Intermediate grooves 114 are generally horizontally and curved. Lower grooves 120 are generally straight at locations distal from the axis but curve as they are disposed closer to the axis. By this construction, grooves are available to grasp or engage the hook regardless of the orientation of the hook.

A second head member or hook engaging member 124 is joined to the second shoulder portion angularly extending toward the longitudinal axis and is a mirror image of first hook engaging member 112. Shoulder member 110 with attached head members 112, 124 cooperate with a facing shoulder member with attached head members on the plier-like tool.

It can now be appreciated that a plier-like tool for removing a fish hook has been presented. The tool has a first handle member with a first axis, top and bottom end portions and a middle portion. A second handle member has a second axis, top and bottom end portions and a middle portion. The middle portions are pivotally connected to each other so that the tool can be maneuvered with one hand, like a pair of pliers, while the other hand remains free to manage the fish or the line.

A first shoulder connected to the top end portion of the first handle member has first and second portions offset from the first longitudinal axis. A first hook engaging member is joined to the first portion of the first shoulder and angularly extends toward the first longitudinal axis to help form a gap for receiving the hook. The grooved inner surface is adapted to engage and grip the hook to facilitate removal thereof from the fish's mouth. The second hook engaging member helps form the gap with the first hook engaging member. The size of the gap will vary with the size of the hook. For best results, the gap should preferably be about one and one half to two times the hook shaft diameter. Smaller gaps require more eye-hand coordination and larger gaps provide room for the hook to move about which is undesirable.

A second shoulder with third and fourth hook engaging members cooperate with the first shoulder and hook engaging members to capture and hold hooks between the grooved surfaces. Exterior surfaces of the top end portions of the handle members define a groove for managing fishing line. Each inner surface of each fish hook engaging members has a distal portion defining a tooth for aiding in hook removal.

The tool effectively dislodges the hook with minimal injury to the fish and with minimal damage to the hook so that the hook can be used again. The tool is as easy to use as a pair of pliers but does not require the hand strength or finger dexterity that regular pliers require. Some grooves on the tool engage the fishing line to keep the line out of the way while the hook is being dislodged and removed. Other grooves receive the shank or other portion of the hook so that the hook can be pushed, pulled, twisted or otherwise manipulated to dislodge the hook from the fish's mouth.

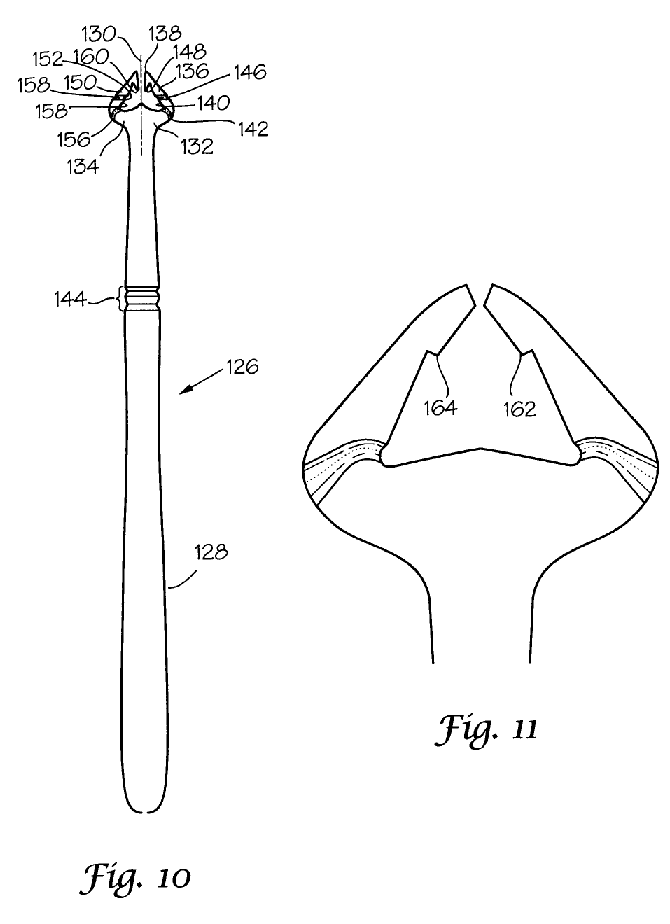

Referring now to FIG. 10, a tool 126 for removing a fish hook from a fish's mouth has an elongated handle 128 with a longitudinal axis 130, top and bottom end portions and a middle portion intermediate the top and bottom end portions. A shoulder connected to the top end portion of handle 128 has first and second portions 132, 134 offset from the longitudinal axis. A first head member or hook engaging member 136 is attached to the first portion 132 of the shoulder and angularly extends toward longitudinal axis 130. First hook engaging member 136 has a tip 138, an inner surface and an outer surface. The inner surface has a curved portion 140 adapted to engage the fish hook to facilitate removal thereof from the fish's mouth. The inner surface and the outer surface preferably define a groove or furrow 142 extending from the outer surface about the inner surface. The junction of first shoulder portion 132 and the first hook engaging member 136 define part of groove or furrow 142.

An exterior surface of the middle portion of handle 128 defines a groove 144 to assist with line management. The exterior surface of the first hook engaging member 136 preferably defines a groove 146 to aid in gripping and leveraging the hook. The inner surface of the first fish hook engaging member 136 has a distal portion defining a downwardly projecting tooth 148 for leveraging the hook.

A second head member or hook engaging member 150 is attached to the second portion 134 of the shoulder and angularly extends toward longitudinal axis 130. Second hook engaging member 150 has a tip 152, an inner surface and an outer surface. The inner surface has a curved portion 154 adapted to engage the fish hook to facilitate removal thereof from the fish's mouth. The inner surface and the outer surface define a groove or furrow 156 extending from the outer surface about the inner surface. The junction of second shoulder portion 134 and the second hook engaging member 150 define part of groove or furrow 156. The exterior surface of the second hook engaging member 150 preferably defines a groove 156 to aid in gripping and leveraging the hook. The inner surface of the second fish hook engaging member 150 has a distal portion defining a downwardly projecting tooth 160 for leveraging the hook. Tips 138, 152 are spaced from one another and adapted to receive the shank of the hook therebetween.

FIG. 11 is an alternate configuration for the head of the tool featuring blunter teeth 162, 164 and fewer grooves.

It can now be appreciated that a simple tool for removing a fish hook from a fish's mouth has been presented. The tool features a handle with a hook engaging member. The handle has grooves for managing the fishing line. The hook engaging member has grooves for receiving the hook to facilitate pushing, pulling, twisting or otherwise manipulating the hook to dislodge it. The simple tool has the advantage of being very simple, while the plier-like tool has the additional advantages that pliers and cutters provide.

While the invention has been described with particular reference to the preferred and alternate embodiments, it will be understood by those skilled in the art that various changes may be made and equivalents may be substituted for elements of the preferred embodiments without departing from invention. For example, while it is contemplated that the tool will be constructed of stainless steel or corrosion resistant metals, it could incorporate plastic or ceramic materials or materials to aid flotation.

As is evident from the foregoing description, certain aspects of the invention are not limited to the particular details of the examples illustrated, and it is therefore contemplated that other modifications and applications will occur to those skilled in the art. For example, while only certain groove orientations have been shown, there is no limit to the configurations possible that would aid in receiving or grasping the hook. Also, there is no set shape or orientation for the teeth. It is accordingly intended that the claims shall cover all such modifications and applications as do not depart from the true spirit and scope of the invention.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A fishhook removing tool comprising:
graduated channels and a longitudinal axis, wherein said graduated channels are disposed parallel to said longitudinal axis.

2. The fishhook removing tool of claim 1, wherein said graduated channels are dimensioned to receive fishhooks of different diameter shank portions.

3. The fishhook removing tool of claim 1, further comprising grooves for receiving wrapped turns of a fishing line.

4. The fishhook removing tool of claim 1, further comprising a head portion having an opening therein, wherein said opening comprises tapers, and wherein said tapers are dimensioned to receive and retain a fishhook, and wherein the fishhook is otherwise unsecured, and wherein a shank portion of the fishhook is disposed outboard of the fishhook removing tool.

5. The fishhook removing tool of claim 1, further comprising at least two sets of gripping ridges.

6. The fishhook removing tool of claim 5, wherein said at least two sets of gripping ridges comprise a tip set, a middle set, a lower set and an arm set.

7. The fishhook removing tool of claim 6, wherein said tip set comprises a principal axis perpendicular to said longitudinal axis.

8. The fishhook removing tool of claim 6, wherein said middle set comprises a principal axis approximately forty-five to sixty degrees from said longitudinal axis.

9. The fishhook removing tool of claim 6, wherein said lower set comprises a principal axis parallel to said longitudinal axis.

10. The fishhook removing tool of claim 6, wherein said arm set comprises a principal axis perpendicular to said longitudinal axis.

11. The fishhook removing tool of claim 1, further comprising a head portion comprised of a pair of mating dual-pronged jaw sections, wherein said pair of mating dual-pronged jaw sections are dimensioned to grasp a fishhook, and wherein said tool further comprises at least two sets of gripping ridges disposed on said pair of mating dual-pronged jaw sections, wherein said at least two sets of gripping ridges are disposed at different angles, and wherein said dispositions of said at least two sets of gripping ridges are different by angles of approximately at least twenty degrees.

12. A method of removing a fishhook, said method comprising the steps of:
obtaining a fishhook removing tool comprising at least two sets of gripping ridges disposed at different angles from each other;
grasping a fishhook engaged with a fish; and
removing the fishhook from the fish.

13. The method of claim 12, further comprising the step of:
securing a shank portion of the fishhook.

14. The method of claim 13, wherein said fishhook removing tool further comprises graduated channels and a longitudinal axis, wherein said graduated channels are disposed parallel to said longitudinal axis.

15. The method of claim 14, wherein said step of securing further comprises the step of securing said shank portion of the fishhook within said channel.

16. The method of claim 12, wherein said step of grasping the fishhook further comprises the step of grasping a shank portion of the fishhook with one of said at least two sets of gripping ridges.

17. The method of claim 16, wherein said step of grasping the fishhook further comprises the step of grasping a curved portion of the fishhook with another of said at least two sets of gripping ridges.

18. The method of claim 16, wherein said step of grasping the fishhook further comprises the step of grasping a barbed tip portion of the fishhook with another of said at least two sets of gripping ridges.

19. A tool comprising a head portion comprised of a pair of mating dual-pronged jaw sections, wherein said pair of mating dual-pronged jaw sections are dimensioned to grasp a fishhook, and wherein said tool further comprises at least two sets of gripping ridges disposed on said pair of mating dual-pronged jaw sections, wherein said at least two sets of gripping ridges are disposed at different angles, and wherein said dispositions are different by angles of approximately at least twenty degrees.

20. The tool of claim 19, further comprising a longitudinal axis and gripping channels, and wherein said gripping channels are disposed within said head portion parallel to said longitudinal axis, and wherein said gripping channels are dimensioned to receive and retain shank portions of fishhooks of different diameters.
